(19) United States
(12) Patent Application Publication
(10) Pub. No.: US 2014/0274324 A1
(43) Pub. Date: Sep. 18, 2014

(54) Online Fantasy Sports System

(71) Applicants: Christian Grant, Huntington Beach, CA (US); Arshan Kapanpour, Huntington Beach, CA (US)

(72) Inventors: Christian Grant, Huntington Beach, CA (US); Arshan Kapanpour, Huntington Beach, CA (US)

(21) Appl. No.: 14/197,461

(22) Filed: Mar. 5, 2014

Related U.S. Application Data
(60) Provisional application No. 61/783,348, filed on Mar. 14, 2013.

(51) Int. Cl. A63F 13/30

(52) U.S. Cl. CPC A63F 13/12
USPC 463/25

(57) ABSTRACT

An apparatus and a method are provided for a multiple league hosting system providing a centralized location where users connected to a communications network compete and place wagers in the course of playing Fantasy sports without being restricted to their respective original leagues. The users access one or more host sites, stored on the multiple league hosting system, and engage in competition and wagering with one another in the course of playing the Fantasy sports. An upload feature enables the users to upload teams from their original Fantasy Sports servers to the multiple league hosting system. The upload feature synchronizes the uploaded teams with the original teams stored on the original Fantasy Sports servers. League management systems on the multiple league hosting system enable the users to manage their teams and wagers without having to access the original Fantasy Sport servers.

### RELATED APPLICATIONS

This application claims the benefit of and priority to U.S. Provisional Application, entitled “Method and System for Participation in Online Fantasy Leagues,” filed on Mar. 13, 2013 having application Ser. No. 61/783,348.

### FIELD

The field of the invention generally relates to Fantasy sports. More specifically, the field of invention generally relates to a system and a method for creating a dynamic online multiple league Fantasy sports hosting system.

### BACKGROUND

Fantasy Sports is a game in which participants act as owners to build a digital team that competes against digital teams created by other Fantasy owners based on the real life statistics generated by real individual players or teams of a professional sport. The accumulation of those statistics, during a designated period of time, allows users to be matched up against each other and compete on a daily, or a weekly basis.

Fantasy Sports wagering traditionally involves multiple participants that play in a league. In some leagues, the participants pay a predetermined price so as to “buy into” the league. The funds gathered from all the participants are then stored by either a League Manager, or an outside third party website. At the end of the season, the funds are distributed to certain owners based on predetermined criteria, for example, division winners, champions, runners up, top three best records, etc. Percentages of the funds awarded to the winners, as well as the frequency with which funds are awarded varies across different leagues. Some leagues distribute funds on a weekly basis, whereas other leagues distribute funds at the end of the regular sports season. Fantasy Sports users typically compete against only other users within their league. The users may manage their teams throughout the entire sports season by trading, waiving, and adding players, generally within a predetermined roster limit, as well as managing starting line ups on a day-to-day basis throughout the entirety of the sports season.

A recent form of Fantasy Sports wagering involves daily and weekly wagers in which individual users log onto websites to enter into either a pool, or one-on-one wagering, at various predetermined buy-ins. The users then compete with daily/weekly drafted teams and play head-to-head for that given day/week. At the end of the day/week one or more of the users having the teams within the pool that scored the most points receives a predetermined amount of the winnings. The host website typically takes a percentage (e.g., 10%) of the awarded funds. Once the day/week is over the users do not have any affiliation with the team they drafted, or with any of the other users.

Another form of daily/weekly Fantasy Sports wagering is salary cap games in which users either join a pool, or wager one-on-one, and are given a certain amount of funds that they may “spend” to create the best possible team for a given day/week. Each digital player costs a certain amount based on how well the corresponding professional player has been performing. The best players are the most expensive, and the worst players are the least expensive. Once each user has filled out a team, using the salary cap amount, the team is included in the pool (or one-on-one) and then competes against other teams for the day/week. Whichever team scores the most points during the day/week is declared the winner, and the user that owns the winning team is awarded a predetermined amount of the funds, with the host website taking a percentage (e.g., 10%).

A Fantasy league is primarily operated by a Fantasy server system based on a particular format for facilitating player/team management by one or more Fantasy client devices in view of a statistical scoring system for determining a winner among members of a Fantasy league supported by the Fantasy client devices. For example, a Fantasy football server system will provide access to Fantasy client devices by way of a Fantasy website for facilitating, among other things, player drafts, player trading, waiver wires, free agent acquisitions and starting lineup selections in view of a statistical scoring system that is based on each football player's weekly performance as a function of the football player's position.

A Fantasy league is secondarily operated by the Fantasy server system based on a particular format for providing access to Fantasy player information by the Fantasy client devices that enhances player/team management by each member of the Fantasy league supported by the Fantasy client devices. For example, a Fantasy football server system currently provides access to Fantasy client devices to a Fantasy website managing Fantasy player information in the form of reports, articles, commentaries, statistics, and the like, that is related, directly and indirectly, to past, present, and future performances of football players whereby the information is intended to serve as a guide for player/team management by each member of the Fantasy football league supported by the Fantasy client devices.

FIG. 1 illustrates an exemplary embodiment of a typical Fantasy league 104 hosted on a Fantasy server 108 which supports a Fantasy sport 112, a league management system 116, and a host site 120. A multiplicity of users 124 access the host site 120 by way of a communications network, such as the Internet, so as to play the Fantasy sport 112, thereby engaging in competition and wagering with one another. The Fantasy sport 112 generally comprises professionally played team-based sports competitions including, but not necessarily limited to American football, Canadian football, Australian Rules football, rugby, ice hockey, baseball, cricket, basketball, team bowling, and the like. It is envisioned, however, that the Fantasy sport 112 may be further utilized with Olympic team events, such as, by way of example, team handball, team tennis, team swimming, water polo, volleyball, and the like.

The league management system 116 comprises a players pool 128 comprising a multiplicity of “digital athletes” representing professional athletes that are engaged in the particular sports competition with which the Fantasy sport 112 is associated. The players pool 128 enables each of the users 124 to assemble and manage a “digital team” typically by signing athletes, trading athletes, cutting athletes, and other similar functions analogously to a professional sports owner. The league management system 116 further comprises an information compilation 132 which may include, by way of example, reports, articles, commentaries, statistics, and the like, that are related, directly or indirectly, to past, present, and future performance of each professional athlete which is represented by a digital athlete stored in the players pool 128. It will be appreciated by those skilled in the art that the information compilation 132 serves as a guide enabling the users 124 to manage their chosen teams by signing, trading, and cutting athletes on their teams based on background information pertaining to the various athletes stored in the players pool 128.

The performance of each professional athlete listed in the players pool 128 is tracked in a scoring portion 136 of the league management system 116. As the athletes acquire achievements, the scoring portion 136 assigns points to the digital athlete based on a predetermined scoring system. Further, the scoring portion 136 schedules games between the teams created by the users 124. Games are typically scheduled on a daily or a weekly basis. A wagers portion 140 of the league management system 116 enables the users 124 to place wagers towards the outcomes of games, as well as the outcome of specific events within each game. The total number of points garnered by the digital athletes comprising each user's team is utilized to determine a winner of each event and game, based on the performance of the professional athletes. Payoffs may be given to the winning users 124 at the end of each day, week, or sports season, depending on predetermined rules for the Fantasy sport 112.

FIG. 2 illustrates an exemplary embodiment of a typical Fantasy Sports server 144 hosting a plurality of Fantasy leagues 104. In the embodiment illustrated in FIG. 2, three of the Fantasy leagues 104 are hosted by the server. It should be understood, however, that more or less than three of the leagues 104 may be simultaneously hosted by the server 144. It should be further understood that each of the leagues 104 pertains to a specific Fantasy sport, and thus each of the leagues 104 is comprised of all those certain components discussed in connection with FIG. 1. The Fantasy Sports server 144 further hosts a plurality of host sites 152 that are each accessible to a user group 154 by way of a communications network such as the Internet. Each of the host sites 152 provides access to one of the Fantasy leagues 104, and thus the corresponding user group 154 accesses the host site 152 to participate in the associated league 104. It will be appreciated that the leagues 104 need not all correspond be the same type of Fantasy sport, but rather each of the leagues 104 may pertain to a different Fantasy sport although they are hosted on the same Fantasy Sports server 144. It will be recognized by those skilled in the art that although members within one of the user groups 154 may interact with one another in connection with one of the leagues 104, members within different user groups 154 generally cannot interact with one another in connection with different leagues 104.

Therefore, a need exists for an improved online Fantasy sports methodology and system for fully utilizing an online wagering system based on Fantasy sports statistics. Additionally, a need exists for an improved online Fantasy sports system and method that allows for direct wagering against other online users across different Fantasy sports leagues. Further, a need exists for an improved system and method for online wagering against other participants in an online Fantasy sports league without the need to join each unique online website for Fantasy leagues. Moreover, a need exists for an improved online system that enables users to upload Fantasy sports teams from differing leagues existing on remote websites.

### SUMMARY

An apparatus and a method are provided for a multiple league hosting system comprising one or more Fantasy sports that are stored on a non-transitory machine-readable medium of the multiple league hosting system. The multiplicity of users accesses one or more host sites, stored on the non-transitory machine-readable medium, and engages in competition and wagering among one another in the course of playing the Fantasy sports. An upload feature enables the users to upload teams of digital athletes from their respective original Fantasy Sports servers to the multiple league hosting system. The upload feature synchronizes the uploaded teams with the original teams stored on their respective original Fantasy Sports servers. League management systems on the multiple league hosting system enable the users to manage their teams and wagers without having to access the original Fantasy Sport server. The league management systems comprise at least a players pool, an information compilation, a scoring portion, and a wagering portion. Portions of the league management system are uploaded and synchronized with the original Fantasy Sports server when teams are uploaded. A money upload feature enables the users to upload funds for wagering purposes. The multiple league hosting system secures the funds and provides a monetary account to each of the users.

The multiple league hosting system provides a centralized location where the multiplicity of users may compete and place wagers with one another in the course of playing the one or more Fantasy sports without being restricted to their respective leagues or to their original Fantasy Sports servers. The multiple league hosting system provides at least one high-stakes league which is reserved for wagers requiring significantly more funds than wagers in the other leagues. A league management system of the high-stakes league includes a wagers portion configured to establish minimum wagers required for participation in the high-stakes league and administers payoffs, prizes, or awards to winning users. Further, the multiple league hosting system provides at least one invitation-only league reserved for users possessing a win percentage which exceeds a predetermined value. An invitation system is configured to track the win percentage of the users in the other leagues and send invitations to the users possessing a suitable win percentage. The invitation-only league is configured to be a prestigious league which serves as an incentive to the users to play and wager more Fantasy sports games.

In an exemplary embodiment, an apparatus for a multiple league hosting system for a multiplicity of users connected by way of a communications network, comprising one or more Fantasy sports that are stored on a non-transitory machine-readable medium of the multiple league hosting system; one or more host sites that are accessible to the multiplicity of users, wherein the one or more host sites are stored on the non-transitory machine-readable medium, and wherein the multiplicity of users engage in competition with, and wagering among, one another in the course of playing the one or more Fantasy sports; an upload feature which enables the multiplicity of users to upload teams of digital athletes from their respective original Fantasy Sports servers to the multiple league hosting system; one or more league management systems comprising at least a players pool, an information compilation, a scoring portion, and a wagering portion; and a money upload feature configured to enable the multiplicity of users to upload funds for wagering purposes, wherein the multiple league hosting system is configured to secure the funds and provide a monetary account to each of the multiplicity of users; wherein the multiple league hosting system provides a centralized location whereby the users may compete and place wagers with one another in the course of playing the one or more Fantasy sports without being restricted to their respective original Fantasy Sports servers.

In another exemplary embodiment, each of the one or more Fantasy sports comprises a competition based on professionally played team-based sporting events able to be wagered on by the multiplicity of users. In another exemplary embodiment, each of the one or more host sites comprises a format and content that is suitable for the professionally played team-based sporting event.

In another exemplary embodiment, the upload feature is accessible to the multiplicity of users by way of the one or more host sites. In another exemplary embodiment, the upload feature synchronizes uploaded teams with the original teams stored on their respective original Fantasy Sports servers. In another exemplary embodiment, scoring of the team is synchronized between the multiple league hosting system and the original Fantasy Sports server hosting the team. In another exemplary embodiment, portions of the league management residing on the original Fantasy Sports server are uploaded and synchronized with the league management on the multiple league hosting system when the team is uploaded, including at least one of a players pool, an information compilation, a scoring portion, and a wagering portion. In another exemplary embodiment, the league management on the multiple league hosting system enables the users to manage their teams without having to access the original Fantasy Sport server.

In another exemplary embodiment, each of the one or more host sites is configured to display categorized team performance projections pertaining to all teams that are currently uploaded to the multiple league hosting system, thereby enabling the multiplicity of users to compare team performance projections so as to exchange wagers among one another. In another exemplary embodiment, the league management stored on the multiple league hosting system is configured to match teams based on the team performance projections, and then to display the matches on the one or more host sites.

In another exemplary embodiment, the wagering portion supports at least one of Head to Head wagers, pool play wagers, side wagers, and third party wagers.

In another exemplary embodiment, the multiple league hosting system is configured to provide at least one high-stakes league which is reserved for wagers requiring significantly more funds than wagers in the other leagues stored on the multiple league hosting system. In another exemplary embodiment, the high-stakes league is administered by a league management system which includes a wagers portion configured to establish minimum wagers required for participation in the high-stakes league. In another exemplary embodiment, the wagers portion administers payoffs, prizes, or awards to winning users.

In another exemplary embodiment, the multiple league hosting system further comprises an invitation-only league which is reserved for users possessing a win percentage which exceeds a predetermined value. In another exemplary embodiment, the multiple league hosting system further comprises an invitation system configured to track the win percentage of the multiplicity of users and send invitations to the users possessing a suitable win percentage. In another exemplary embodiment, the invitation-only league is configured to be a prestigious league which is promoted as an incentive to the multiplicity of users to play more of the one or more Fantasy sports. In another exemplary embodiment, the invitation-only league is administered by a league management system which includes a wagers portion configured to regulate wagers and administers payoffs to winning users. In another exemplary embodiment, the wagers portion is configured to administer prizes, awards, or additional amenities to winning users.

In an exemplary embodiment, a method for providing an interactive gaming system for a plurality of users connected via a communication network comprising the activities of creating at least one community for the interactive gaming system including rules defining parameters for the gaming system, the community including the plurality of users; allocating an initial bankroll to each of the plurality of users; enabling each of the plurality of users to wager at least a portion of their allocated bankroll in accordance with the rules; providing projections to the plurality of users for assisting them in making a wager; and ranking each of the plurality of users based on success in wagering by each of the plurality of users. In another exemplary embodiment, said activity of creating comprises setting the rules, wherein the rules identify at least one type of contest able to be wagered on by the plurality of users; at least one type of wager to be associated with the selected contest. In another exemplary embodiment, said at least one type of contest includes at least one of a sporting event. In another exemplary embodiment, at least one type of wager includes selecting the outcome of the contest and selecting an outcome of an event within the contest. In another exemplary embodiment, the rules include an allotment of wager types including at least one of a max bet representing a maximum amount of the user's bankroll able to be wagered on particular contest, and a lock bet enabling a user to multiply an amount able to be won on a particular wager without risking an additional amount of the bankroll. In another exemplary embodiment, the contest comprises a Fantasy sports league based on professionally played team-based sporting events able to be wagered on by the plurality of users. In another exemplary embodiment, the one community for interactive gaming utilizes information received from a host website containing drafted teams by the plurality of users on the instant system.

### BRIEF DESCRIPTION OF THE DRAWINGS

The drawings refer to embodiments of the present invention in which:

FIG. 1 illustrates an exemplary embodiment of a typical Fantasy league;

FIG. 2 illustrates an exemplary embodiment of a typical Fantasy Sports server hosting a plurality of leagues; and

FIG. 3 illustrates an exemplary embodiment of a multiple league hosting system, in accordance with the present invention.

While the present invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present invention.

### DETAILED DISCUSSION

In the following description, numerous specific details are set forth in order to provide a thorough understanding of the present invention. It will be apparent, however, to one of ordinary skill in the art that the present invention may be practiced without these specific details. In other instances, well known components or methods have not been described in detail but rather in a block diagram, or a schematic, in order to avoid unnecessarily obscuring the present invention. Further specific numeric references such as “first driver,” may be made. However, the specific numeric reference should not be interpreted as a literal sequential order but rather interpreted that the “first driver” is different than a “second driver.” Thus, the specific details set forth are merely exemplary. The specific details may be varied from and still be contemplated to be within the spirit and scope of the present invention. The term “coupled” is defined as meaning connected either directly to the component or indirectly to the component through another component.

In general, the present invention describes an apparatus and a method for a multiple league hosting system which provides a centralized location where users connected to a communications network compete and place wagers in the course of playing one or more Fantasy sports without being restricted to their respective original leagues. The users access one or more host sites, stored on the multiple league hosting system, and engage in competition and wagering among one another in the course of playing the Fantasy sports. An upload feature enables the users to upload teams from their original Fantasy Sports servers to the multiple league hosting system. The upload feature synchronizes the uploaded teams with the original teams stored on the original Fantasy Sports servers. League management systems on the multiple league hosting system enable the users to manage their teams and wagers without having to access the original Fantasy Sport servers. The league management systems comprise at least a players pool, an information compilation, a scoring portion, and a wagering portion. Portions of the league management system are uploaded and synchronized with the original Fantasy Sports server when the teams are uploaded. A money upload feature enables the users to upload funds for wagering purposes. The multiple league hosting system secures the funds and provides a monetary account to each of the users.

FIG. 3 illustrates an exemplary embodiment of a multiple league hosting system 158, in accordance with the present invention. A multiplicity of user groups 154, each comprising a multiplicity of users 124, accesses the multiple league hosting system 158 by way of a host site 148 through a communications network, such as the Internet, so as to play and wager the Fantasy sport 112. Although only one host site 148 is illustrated in FIG. 3, it should be understood that the multiple league hosting system 158 may support a plurality of host sites, depending on the number of different Fantasy sports 112 that are simultaneously being offered to the users 124. As discussed with reference to FIG. 1, the Fantasy sport 112 comprises professionally played team-based sports competitions which may include, but are not necessarily limited to American football, Canadian football, Australian Rules football, rugby, ice hockey, baseball, cricket, basketball, team bowling, and the like. Further, the Fantasy sport 112 may be utilized with Olympic team events, such as, by way of example, team handball, team tennis, team swimming, water polo, volleyball, and the like. It is envisioned that the format and content of the various host sites 148 provided to the user groups 154 will vary depending on the particular sports competition utilized for the Fantasy sport 112.

In addition to having access to the multiple league hosting system 158, the user groups 154 retain access to their respective Fantasy Sports servers 144, as discussed in connection with FIG. 2. Thus, all the users 124 accessing the host site 148 retain access to their original respective teams of digital athletes that were assembled and stored on their respective Fantasy Sports servers 144, as discussed with reference to FIG. 1. The multiple league hosting system 158 is configured to enable all the users 124 to upload their respective teams of digital athletes from their respective Fantasy Sports servers 144 so as to engage in competition and wagering with one another across multiple leagues 104. It is envisioned that the multiple league hosting system 158 will provide an upload feature which is accessible to the users 124 by way of the host site 148. Once a team is uploaded to the multiple league hosting system 158, the team is synchronized with the team on the Fantasy Sports server 144. Moreover, the team's scoring in games and events, based on the performance of the professional athletes, is synchronized with the scoring on the Fantasy Sports server 144. Thus, the points earned by the team on the Fantasy Sports server 144 are reflected on the multiple league hosting system 158. Further, upon uploading a team to the multiple league hosting system 158, portions of the league management 116 are uploaded and synchronized to a standard league management 162 of the multiple league hosting system 158. In an embodiment, the players pool 128, the information compilation 132, and the scoring portion 136 are synchronized between the league management 116 and the standard league management 162. The standard league management 162 provides each of the users 124 with all the features of the league management 116, thereby enabling the users 124 to effectively manage their teams without having to return to the Fantasy Sport servers 144. It will be recognized that the multiple league hosting system 158 provides a centralized location whereby the users 124 may compete and place wagers with one another in the course of playing the Fantasy Sport 112 without being restricted to their respective Fantasy Sports servers 144.

Once the users 124 have uploaded their digital teams to the multiple league hosting system 158, the users 124 are able to place wagers against one another on a per day/week basis, based on daily/weekly team performance projections. The team performance projections may be based on a variety of methods for scoring Fantasy sports games, and thus the team performance projections are predetermined before the users 124 place wagers. In an embodiment, categorized team projections displayed on the host site 148 enable the users 124 to view all of the teams that are currently uploaded to the multiple league hosting system 158, thereby enabling the users 124 to compare team projections so as to submit wagers. In another embodiment, the standard league management 162 is configured to match teams with one another, based on the team performance projections, and then display the matches on the host site 148.

It will be appreciated that before the users 124 may place or accept wagers requiring a monetary exchange, the users 124 must first create a positive account balance. Preferably, the host site 148 includes payment features to enable users 124 to create a positive account balance via various payment systems, including for example, credit cards, debit cards, PayPal, Bitcoin, etc., and the multiple league hosting system 158 operates as a secure bank which provides each user with a monetary account, thereby ensuring that all the users 124 possess funds available for wagering. Once all the users 124 have been credited the appropriate funds, each of the users 124 may wager directly with other users in Head to Head wagers, or may join a pool play wager. In one embodiment, a specified duration of the Head to Head wagers and pool play wagers is one day. In another embodiment, the specified duration of the heat-to-heat wager and pool play wagers is one week.

Head to Head wagers enable the users 124 to submit wagers directly to other users. The users 124 receiving wager submissions may respond by accepting the wager, countering the wager, or declining the wager. Once the specified duration of the wager has elapsed, the users 124 possessing the teams that scored the most points win the wagered funds. In an embodiment, 10% of the wagered funds are paid to the operator of the multiple league hosting system 158 as a fee for hosting the game. In another embodiment, at least a portion of the wagers may be “friendly bets,” comprising zero funds.

Pool play wagers enable the users 124 to join with a group of other users where each of the users 124 pays a fixed wager into a pool and then selects an outcome of a game or an event. The pool is evenly divided between those users 124 that made the winning selection. Preferably, there are no odds involved; each winner's payoff depends simply on the number of users 124 in the group and the number of winning users. It will be recognized that a wide variety of different wagering systems may be utilized with the multiple league hosting system 158 and the host site 148 without detracting from the spirit and scope of the present invention.

Referring again to FIG. 3, the multiple league hosting system 158 further comprises a Diamond league 166 which is administered by a Diamond league management 170. The Diamond league comprises a separate league within the multiple league hosting system 158 that is reserved for users that wager significantly higher amounts than the users 124 of the other leagues. The Diamond league management 170 is substantially similar to the standard league management 162, with the exception that the Diamond league management 170 comprises a Diamond league wagers portion 174 which establishes minimum wagers required for participation in the Diamond League 166. Further, the Diamond league wagers portion 174 administers payoffs to winning users, and may further administer prizes and awards which may be given out to winning users in the Diamond league 166. It is envisioned that the Diamond league 166 may provide additional amenities to the users 124, such as, by way of example, a variety of tools for assisting the users 124 with analyzing team performance projections, and the like. It should be appreciated that there could be more than one Diamond league, and that such separate leagues could have any number of designations or names.

In the illustrated embodiment of FIG. 3, the standard league management 162 and the Diamond league management 170 are coupled to an invitation system 178 which tracks the performance of the users 124 playing the Fantasy sport 112. The invitation system 178 serves to identify those certain users possessing a win percentage exceeding a predetermined value and then invite those users to participate in a Champions league 182. The Champions league 182 is intended to be a prestigious league which serves as an incentive to the users 124 to play and wager as many games as possible in the hope of being invited to join the Champions league 182. With the exception of the invitation system 178, the Champions league 182 operates substantially similarly to the Diamond league 166. The Champions league 182 is administered by a Champions league management 186. The Champions league management 186 is substantially similar to the Diamond league management 170, with the exception that the Champions league management 186 comprises a Champions league wagers portion 190 which regulates wagers and administers payoffs to winning users in the Champions league 182. The Champions league management 186 may further administer prizes, awards, and additional amenities to winning users in the Champions league 182. It is envisioned that the prizes, awards, and additional amenities available to winning users in the Champions league 182 greatly exceed those available to users playing the Fantasy sport 112 by way of the standard league and the Diamond league.

It is envisioned that the multiple league hosting system 158 provides the users 124 with a Side Wagers feature. The Side Wagers feature enables the users 124 to submit wagers to other users in connection with specific events within a Fantasy sports game. For example, when the Fantasy sport 112 comprises a Fantasy football game, one user may submit a wager that his Running Back will score higher during a particular day or week than another user's Running Back. Upon receiving the wager submission, the recipient may accept the wager, reject the wager, or counter the wager. It will be recognized by those skilled in the art that the Side Wagers feature enables the users 124 to wager on events within the Fantasy sports game, either in addition, or separately to the wagers already connected with the outcome of the Fantasy sports game.

In an embodiment, the multiple league hosting system 158 provides the users 124 with a Third Party Wagering feature which enables the users 124 to place wagers in connection with games between the teams owned by other users. The Third Party Wagering feature enables each of the users 124 to see a list of all games that have pending wagers for the current day, as well as for the current week, and then submit wagers to other third party users. It will be recognized that the Third Party Wagering feature enables the users 124 that do not have a digital team, or have a poorly performing digital team, to continue wagering competitively within the multiple league hosting system 158.

In one embodiment, the Side Wagers feature and the Third Party Wagering feature are available only to the users 124 that have been invited into the Champions league 182. In another embodiment, the Side Wagers feature and the Third Party Wagering feature may be available to only those users that are members of the Diamond league 166 or the Champions league 182. In still another embodiment, the Side Wagers feature and the Third Party Wagering feature may be available to all the user 124 participating in the Fantasy sport 112.

In one embodiment, the software used to facilitate the host site 148, the Fantasy sport 112, and the leagues 166, 182 discussed herein may be embodied onto a non-transitory machine-readable medium. A machine-readable medium includes any mechanism that stores information in a form readable by a machine (e.g., a computer). For example, a machine-readable medium includes read only memory (ROM); random access memory (RAM); magnetic disk storage media; optical storage media; flash memory devices; Digital VideoDisc (DVD's), EPROMs, EEPROMs, FLASH memory, magnetic or optical cards, or any type of media suitable for storing electronic instructions.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms may be written in a number of different software programming languages such as C, C+, or other similar languages. Also, an algorithm may be implemented with lines of code in software, configured logic gates in software, or a combination of both. In an embodiment, the logic consists of electronic circuits that follow the rules of Boolean Logic, software that contain patterns of instructions, or any combination of both.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

While some specific embodiments of the present invention have been shown the invention is not to be limited to these embodiments. For example, most functions performed by electronic hardware components may be duplicated by software emulation. Thus, a software program written to accomplish those same functions may emulate the functionality of the hardware components in input-output circuitry. The present invention is to be understood as not limited by the specific embodiments described herein, but only by scope of the appended claims.

1. An apparatus for a multiple league hosting system for a multiplicity of users connected by way of a communications network, comprising:
one or more Fantasy sports that are stored on a non-transitory machine-readable medium of the multiple league hosting system;
one or more host sites that are accessible to the multiplicity of users, wherein the one or more host sites are stored on the non-transitory machine-readable medium, and wherein the multiplicity of users engage in competition with, and wagering among, one another in the course of playing the one or more Fantasy sports;
an upload feature which enables the multiplicity of users to upload teams of digital athletes from their respective original Fantasy Sports servers to the multiple league hosting system;
one or more league management systems comprising at least a players pool, an information compilation, a scoring portion, and a wagering portion; and
a money upload feature configured to enable the multiplicity of users to upload funds for wagering purposes, wherein the multiple league hosting system is configured to secure the funds and provide a monetary account to each of the multiplicity of users;
wherein the multiple league hosting system provides a centralized location whereby the users may compete and place wagers with one another in the course of playing the one or more Fantasy sports without being restricted to their respective original Fantasy Sports servers.

2. The apparatus of claim 1, wherein each of the one or more Fantasy sports comprises a competition based on professionally played team-based sporting events able to be wagered on by the multiplicity of users.

3. The apparatus of claim 2, wherein each of the one or more host sites comprises a format and content that is suitable for the professionally played team-based sporting event.

4. The apparatus of claim 1, wherein the upload feature is accessible to the multiplicity of users by way of the one or more host sites.

5. The apparatus of claim 1, wherein the upload feature synchronizes uploaded teams with the original teams stored on their respective original Fantasy Sports servers.

6. The apparatus of claim 5, wherein scoring of the team is synchronized between the multiple league hosting system and the original Fantasy Sports server hosting the team.

7. The apparatus of claim 5, wherein portions of the league management residing on the original Fantasy Sports server are uploaded and synchronized with the league management on the multiple league hosting system when the team is uploaded, including at least one of a players pool, an information compilation, a scoring portion, and a wagering portion.

8. The apparatus of claim 7, wherein the league management on the multiple league hosting system enables the users to manage their teams without having to access the original Fantasy Sport server.

9. The apparatus of claim 1, wherein each of the one or more host sites is configured to display categorized team performance projections pertaining to all teams that are currently uploaded to the multiple league hosting system, thereby enabling the multiplicity of users to compare team performance projections so as to exchange wagers among one another.

10. The apparatus of claim 9, wherein the league management stored on the multiple league hosting system is configured to match teams based on the team performance projections, and then to display the matches on the one or more host sites.

11. The apparatus of claim 1, wherein the wagering portion supports at least one of Head to Head wagers, pool play wagers, side wagers, and third party wagers.

12. The apparatus of claim 1, wherein the multiple league hosting system is configured to provide at least one high-stakes league which is reserved for wagers requiring significantly more funds than wagers in the other leagues stored on the multiple league hosting system.

13. The apparatus of claim 12, wherein the high-stakes league is administered by a league management system which includes a wagers portion configured to establish minimum wagers required for participation in the high-stakes league.

14. The apparatus of claim 13, wherein the wagers portion administers payoffs, prizes, or awards to winning users.

15. The apparatus of claim 1, wherein the multiple league hosting system further comprises an invitation-only league which is reserved for users possessing a win percentage which exceeds a predetermined value.

16. The apparatus of claim 15, wherein the multiple league hosting system further comprises an invitation system configured to track the win percentage of the multiplicity of users and send invitations to the users possessing a suitable win percentage.

17. The apparatus of claim 15, wherein the invitation-only league is configured to be a prestigious league which is promoted as an incentive to the multiplicity of users to play more of the one or more Fantasy sports.

18. The apparatus of claim 15, wherein the invitation-only league is administered by a league management system which includes a wagers portion configured to regulate wagers and administers payoffs to winning users.

19. The apparatus of claim 18, wherein the wagers portion is configured to administer prizes, awards, or additional amenities to winning users.

20. A method for providing an interactive gaming system for a plurality of users connected via a communication network comprising the activities of:
creating at least one community for the interactive gaming system including rules defining parameters for the gaming system, the community including the plurality of users;
allocating an initial bankroll to each of the plurality of users;
enabling each of the plurality of users to wager at least a portion of their allocated bankroll in accordance with the rules;
providing projections to the plurality of users for assisting them in making a wager; and
ranking each of the plurality of users based on success in wagering by each of the plurality of users.

21. The method of claim 20, wherein said activity of creating comprises setting the rules, wherein the rules identify at least one type of contest able to be wagered on by the plurality of users; at least one type of wager to be associated with the selected contest.

22. The method of claim 21, wherein said at least one type of contest includes at least one of a sporting event.

23. The method of claim 21, wherein at least one type of wager includes selecting the outcome of the contest and selecting an outcome of an event within the contest.

24. The method of claim 21, wherein the rules include an allotment of wager types including at least one of a max bet representing a maximum amount of the user's bankroll able to be wagered on particular contest, and a lock bet enabling a user to multiply an amount able to be won on a particular wager without risking an additional amount of the bankroll.

25. The method of claim 20, whereby the contest comprises a Fantasy sports league based on professionally played team-based sporting events able to be wagered on by the plurality of users.

26. The method of claim 20, whereby the one community for interactive gaming utilizes information received from a host website containing drafted teams by the plurality of users on the instant system.
